(19) United States
(12) Patent Application Publication
(10) Pub. No.: US 2025/0276262 A1
(43) Pub. Date: Sep. 4, 2025

(54) FILTER STRUCTURE

(71) Applicant: TOYO ALUMINIUM EKCO PRODUCTS CO., LTD., Osaka-shi, Osaka (JP)

(72) Inventor: Masashi ADACHI, Osaka-shi, Osaka (JP)

(73) Assignee: TOYO ALUMINIUM EKCO PRODUCTS CO., LTD., Osaka-shi, Osaka (JP)

(21) Appl. No.: 18/859,093

(22) PCT Filed: Apr. 27, 2023
(86) PCT No.: PCT/JP2023/016562

§ 371 Date: Oct. 22, 2024

(30) Foreign Application Priority Data
Apr. 28, 2022 (JP) 2022-074621

(51) Int. Cl. B01D 39/14; B01D 46/10

(52) U.S. Cl. CPC B01D 39/14; B01D 46/10; B01D 2239/0457

(57) ABSTRACT

A filter structure (81) is used for filtering a gas passing therethrough by being attached to an object, and includes a filter layer made of a sheet-like member having air permeability, and an adhesive layer formed on at least a part of one surface of the filter layer and configured to attach to the object. The adhesive layer contains 3 wt % or more of a flame retardant. With such a configuration, flame retardance is imparted to the adhesive layer, and thus it is possible to improve flame retardance of the entire filter structure (81).

### TECHNICAL FIELD

The present invention relates to a filter structure, and in particular to a filter structure for filtering a gas passing therethrough by being attached to an object such as a range hood, an air conditioner, an air purifier, or a vent hole.

### BACKGROUND ART

A filter structure that is mounted on a metal filter or a straightening plate of a range hood, an air inlet of an air conditioner or an air purifier, indoor and outdoor vent holes, or the like to filter air passing therethrough is described in PTL 1, PTL 2, or the like. The filter structures described in these literatures have a structure in which an adhesive layer is formed on one surface of a sheet-like filter layer made of a nonwoven fabric or the like. A thin release sheet is usually attached to a surface of the adhesive layer. Further, a filter structure using an acrylic hot melt adhesive as this adhesive layer is described in PTL 3. Further, a filter that can be attached to a range hood or the like by including an adhesive layer in which an adhesive is sprayed on one surface of a nonwoven fabric layer is described in PTL 4.

### CITATION LIST

### Patent Literature

PTL 1: JP2002-85927A
PTL 2: JP2017-15297A
PTL 3: JP2016-36801A
PTL 4: JP2018-161598A

In order to attach a filter structure as described in PTL 1 to PTL 4 to an attachment target such as a range hood, the attachment is performed by removing a release film attached to a surface of an adhesive layer to expose an adhesive surface of the adhesive layer, and then positioning the adhesive surface to an attachment location, and, for example, pressing the adhesive surface for attaching. Here, in a case where the filter structure as described in PTL 1 to PTL 4 is attached to a range hood or the like installed above a gas range of a kitchen, in order to impart flame retardance to a nonwoven fabric constituting the filter structure, flame retardant fibers are used as fibers constituting the nonwoven fabric, or the fibers are treated with a flame retardant (for example, by attaching a fatty acid metal salt such as aluminum stearate to the fibers). By imparting such flame retardance, in a case of normal heating cooking in the kitchen, a flame does not come into direct contact with the filter structure during the heating cooking, so that the filter structure does not easily melt or burn due to heat during heating cooking. However, in a case where cooking is performed in which a high-alcohol liquor such as brandy is dropped into a frying pan to evaporate an alcohol component at once at the time of heating cooking of food, as in the so-called flambe, a large flame may rise due to the evaporated alcohol. In such a case, the flame may come into direct contact with the filter structure, and in this case, the nonwoven fabric constituting the filter structure may burn, but if the flame retardance is imparted to the nonwoven fabric as described above, the nonwoven fabric itself is less likely to burn. On the other hand, in a case where the filter structure has a configuration in which the adhesive layer is formed on one surface of the nonwoven fabric, the adhesive layer is made of a resin adhesive, a rubber adhesive, or the like, which is flammable, but while attaching to a range hood or the like, the nonwoven fabric is present on an opposite side of the adhesive layer, and is the farthest away from a gas stove, so that it is considered that the adhesive layer would not burn as long as the nonwoven fabric itself does not burn. However, contrary to this expectation, when the adhesive layer is formed on the entire one surface of the nonwoven fabric by spray coating, it has been found that the filter structure may easily burn when the flame comes into direct contact with the filter structure, as in the flambe. Although the reason is unclear, it is presumed that when the adhesive layer is formed on the entire one surface of the nonwoven fabric by spray coating, an adhesive is scattered over the entire one surface of the nonwoven fabric, and covers some or most of the fibers constituting the nonwoven fabric, if the flame comes into contact with the adhesive that covers the fibers of the nonwoven fabric and spreads to the adhesive, or if the flame reaches the adhesive layer through gaps between the fibers and spreads to the adhesive layer, even if the flame retardance is imparted to the nonwoven fabric, the flame may spread throughout the entire nonwoven fabric before the flame retardance is exerted.

In view of the above problems in the related art, an object of the invention is to provide a filter structure that maintains flame retardance of the entire filter structure.

### SUMMARY OF INVENTION

In order to achieve the above object, a filter structure according to a first aspect of the invention is a filter structure for filtering a gas passing therethrough by being attached to an object, the filter structure including: a filter layer made of a sheet-like member having air permeability; and an adhesive layer formed on at least a part of one surface of the filter layer and configured to attach to the object, in which the adhesive layer contains 3 wt % or more of a flame retardant.

With such a configuration, it is possible to obtain an action 1 in which flame retardance is imparted to the adhesive layer.

A filter structure according to a second aspect of the invention is one having the configuration of the invention in the first aspect, in which the flame retardant is an organic non-halogen flame retardant.

With such a configuration, it is possible to obtain an action 2 in which a toxic gas is less likely to be generated due to decomposition by heat of the flame retardant.

A filter structure according to a third aspect of the invention is one having the configuration of the invention in the first aspect or the second aspect, in which the flame retardant is contained in the adhesive layer in a range of 10 wt % or more and 30 wt % or less.

With such a configuration, it is possible to obtain an action 3 in which the flame retardance of the adhesive layer is further improved and a required adhesive force can be secured when the filter structure is attached to an attachment object.

A filter structure according to a fourth aspect of the invention is one having the configuration of the invention in the first aspect or the second aspect, in which at a location on the filter layer where the adhesive layer is formed, the adhesive layer is formed in a range of 5 g/m² or more and 50 g/m² or less with respect to the filter layer.

With such a configuration, it is possible to obtain an action 4 in which the required adhesive force can be secured when the filter structure is attached to the attachment object.

A filter structure according to a fifth aspect of the invention is one having the configuration of the invention in the first aspect or the second aspect, in which the adhesive layer is formed by spray coating.

With such a configuration, it is possible to obtain an action 5 in which the flame retardance is also imparted to the adhesive layer that can be formed by the spray coating.

A filter structure according to a sixth aspect of the invention is one having the configuration of the invention in the first aspect or the second aspect, in which the other surface of the filter layer, which corresponds to a back surface of a range where the adhesive layer is formed on the filter layer, has a category of 3 in a flammability test according to a JIS L1091A-1 method (45° micro burner method).

With such a configuration, it is possible to obtain an action 6 in which the other surface of the filter is less likely to burn.

A filter structure according to a seventh aspect of the invention is one having the configuration of the invention in the first aspect or the second aspect, in which the object is a range hood.

With such a configuration, it is possible to obtain an action 7 in which the filter structure has high flame retardance, and thus can be used more safely even when a fire is used in a gas stove.

As described above, the filter structure according to the first aspect of the invention can obtain the above action 1, and thus it is possible to improve the flame retardance of the entire filter structure.

The filter structure according to the second aspect of the invention can obtain the above action 2 in addition to an effect of the invention in the first aspect, and thus is safer for a human body.

The filter structure according to the third aspect of the invention can obtain the above action 3 in addition to an effect of the invention in the first aspect or the second aspect, and thus the flame retardance of the entire filter structure is further improved, and the filter structure is prevented from peeling off or falling off.

The filter structure according to the fourth aspect of the invention can obtain the above action 4 in addition to the effect of the invention in the first aspect or the second aspect, and thus the filter structure is prevented from peeling off or falling off, and filtration of a gas through the filter layer is not inhibited.

The filter structure according to the fifth aspect of the invention can obtain the above action 5 in addition to the effect of the invention in the first aspect or the second aspect, and thus the flame retardance of the entire filter structure is improved even if the adhesive layer is formed by the spray coating.

The filter structure according to the sixth aspect of the invention can obtain the above action 6 in addition to the effect of the invention in the first aspect or the second aspect, and thus the flame retardance of the entire filter structure is improved.

The filter structure according to the seventh aspect of the invention can obtain the above action 7 in addition to the effect of the invention in the first aspect or the second aspect, and thus can be suitably used in the range hood.

### BRIEF DESCRIPTION OF DRAWINGS

FIG. 1 is a diagram showing an example of a case where a filter structure according to an embodiment of the invention is attached to a metal filter of a range hood.

### DESCRIPTION OF EMBODIMENTS

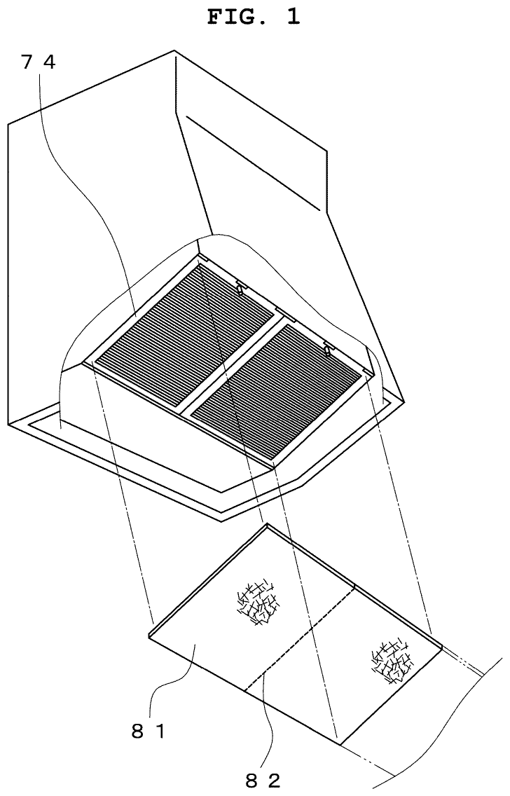

FIG. 1 is a diagram showing an example of a case where a filter structure according to an embodiment of the invention is attached to a metal filter of a range hood. Referring to the drawing, the range hood includes an air intake on an inside of a boot-shaped hood. A metal filter 74 is attached to an opening of the air intake in order to prevent foreign matter from entering an inside of the air intake. An outer surface of the metal filter 74 has a rectangular shape including a pair of opposing sides and a pair of opposing other sides. Referring to the drawing, a filter structure 81 includes a filter layer made of a sheet-like member having air permeability and an adhesive layer formed on at least a part of one surface of the filter layer and configured to attach to an object, and is cut to a predetermined length according to a size of the metal filter 74, and longitudinal perforations 82 are formed predetermined intervals in a width direction to assist in cutting. The perforation 82 may be omitted as necessary. The filter structure 81 may be cut into a desired size in advance, or the rolled filter structure 81 may be cut appropriately when used. As described above, the adhesive layer is formed on the one surface of the filter structure 81 by applying an adhesive (not shown). The filter structure 81 is used for filtering a gas passing therethrough by being attached to an object, and includes a sheet-like filter layer S for filtering air passing therethrough, and an adhesive layer N formed on at least a part of one surface of the filter layer S and configured to attach to the object. Before use, a peelable release sheet layer is laminated on a surface of the adhesive layer N, and when in use, the release sheet layer is peeled off and the filter structure 81 is attached to the object as if attaching a seal.

The filter layer S of this example is made of, for example, a nonwoven fabric, a loom fabric, or a knitted fabric. In order to achieve both collection of oil smoke, dust, and the like and flow of a gas, and to ensure a practical strength, it is preferable that a thickness is in a range of 0.3 mm to 15.0 mm and a basis weight is in a range of 20 g/m² to 200 g/m². When the thickness is less than 0.3 mm or the basis weight is less than 20 g/m², the practical strength may be insufficient, and a sufficient collection function may not be exerted. When the thickness exceeds 15.0 mm, or the basis weight exceeds 200 g/m², flow resistance of the gas increases, which may impair its practicality as an air filter. A material of the filter layer S may be, but is not limited to, polyesters such as PET, polypropylene or copolymers mainly including propylene, acrylic including modacrylic, or the like. When the filter structure of the invention is used as a filter structure for a range hood, if the filter layer S is made of, for example, a nonwoven fabric, it is preferable to use flame retardant fibers as fibers constituting the filter layer S, or to treat the fibers with a flame retardant (for example, by attaching a fatty acid metal salt such as aluminum stearate to the fibers). In addition to flame retardance, the filter layer S may be processed to exert antiviral, antibacterial, antifungal, and other functions.

The adhesive layer N is formed on at least a part of the one surface of the filter layer S. An adhesive for forming the adhesive layer N is not particularly limited, and for example, a two-part mixture type adhesive containing a base agent and a curing agent, such as a two-part mixture type polyurethane adhesive, or a hot melt adhesive, such as an acrylic hot melt adhesive, may be used. The adhesive may contain, if necessary, an additive such as a tackifier for improving adhesion, an ultraviolet absorber, a filler, a colorant, an antioxidant, a defoaming agent, or a light stabilizer, and various additives for preventing a decrease in adhesive force, adhesive residue, and the like at a low temperature. A method of forming the adhesive layer N on the filter layer S may be a known method. For example, a method may be adopted in which the adhesive is directly applied to the filter layer S, or the adhesive is temporarily applied to a peelable release sheet layer or the like as described later, and then the release sheet layer is brought into contact with the filter layer S to transfer the adhesive to the filter layer S, thereby indirectly applying the adhesive to form a coating film, and then the coating film is dried (solidified). A method of applying the adhesive layer N directly or indirectly to the filter layer S is not limited, and may be performed by, for example, a roller, a spray, a brush, or printing. That is, any of a roll coater method, a comma coater method, a die coater method, an ink jet method, a reverse coater method, a silk screen method, a gravure coater method, and the like using a known apparatus may be adopted. In a case of direct applying, for example, the adhesive can be blown entirely or partly on one surface of the filter layer S by spraying, thereby forming the adhesive layer N on the filter layer S. In addition, in a case of indirect applying, for example, a method or the like may be adopted in which the adhesive is printed on, using a roll or the like, a peelable release sheet layer to which a silicone coat is applied, and then an adhesive layer N side of the release sheet layer is brought into contact with the filter layer S and pressed using a roll or the like, thereby transferring the adhesive layer N to the filter layer S.

The release sheet layer may be, for example, a PET film with a silicone coat formed on at least one surface thereof. By providing the release sheet layer, the surface of the adhesive layer N is protected, so that the adhesive layer N can be prevented from sticking to objects other than an intended object before the filter structure 81 is used. In addition, for example, it is possible to stack a plurality of filter structures 81, thereby improving ease of handling. In use, it is sufficient that the release sheet layer is peeled off, and the exposed adhesive layer N is attached to the object like a seal. As a material of the release sheet layer, in addition to the PET film, cellophane, a resin film other than PET, paper subjected to surface processing such as a resin coat, a metal sheet, or the like may be used. The adhesive layer N may be formed by a spraying method as described above, may be formed into a band shape or a grid shape by pattern printing, or may be formed with images with designed characters, in addition to letters, symbols, and figures. A maximum peeling load K of the adhesive layer N at 5° C. is set preferably in a range of 0.01 N/mm to 0.05 N/mm, and more preferably in a range of 0.02 N/mm to 0.04 N/mm. By setting the adhesive layer N in this manner, it is possible to reliably prevent the adhesive layer N from falling off the object even under a low temperature condition of 5° C.

In the filter structure 81 of this example, it is sufficient that the adhesive layer N is formed on at least a part of the one surface of the filter layer S, and it is not necessarily required to form the adhesive layer N on the entire surface, but the formation of the adhesive layer N on the entire surface of the filter layer S is not excluded. As an example of forming the adhesive layer N on the entire surface of the filter layer S, the adhesive can be sprayed on the one surface of the filter layer S in an amount that does not inhibit air permeability of the filter layer S, thereby forming the adhesive layer N on the entire surface of the filter layer S. Of course, even in a case of spray coating, it is possible to adopt a mode in which the adhesive layer N is formed only on a part of the filter layer S. For example, when the filter layer S has a rectangular shape, it is possible to adopt a mode in which the adhesive layer N is formed only in the vicinity of an outer periphery of the rectangular shape, and the adhesive layer N is not formed on an inner side. In addition, the adhesive layer N may be partially formed by pattern coating. For example, when the filter layer S has a rectangular shape, it is possible to adopt a mode in which the band-shaped adhesive layer N is formed only on an outer periphery or in the vicinity of the outer periphery of the rectangular shape, and the adhesive layer N is not formed on an inner side. In addition to the formation of the band-shaped adhesive layer N on the outer periphery or in the vicinity of the outer periphery of the rectangular shape, it is also possible to adopt a mode in which the band-shaped adhesive layer N having a strip shape or a grid shape is formed on the inner side. In a case of pattern coating, since gaps between the fibers are often completely filled with the adhesive in a portion where the adhesive is formed, it is preferable to adopt a mode in which the adhesive layer N is formed on at least a part of the one surface of the filter layer S. For a preferred coating amount (formation amount) of the adhesive layer N, a formation amount of the adhesive layer N with respect to the filter layer S is preferably 5 g/m² or more and 50 g/m² or less, and more preferably 15 g/m² or more and 30 g/m² or less at a location (one surface) on the filter layer S where the adhesive layer N is formed. With such a configuration, a required adhesive force can be secured when the filter structure 81 is attached to an attachment object, and thus the filter structure 81 is prevented from peeling off or falling off, and filtration of a gas through the filter layer S is not inhibited.

In the filter structure 81 of the invention, the adhesive layer N contains 3 wt % or more of a flame retardant. With such a configuration, flame retardance is imparted to the adhesive layer N, and thus it is possible to improve flame retardance of the entire filter structure 81. Various flame retardants may be used as long as the flame retardants do not impair effects of the invention. The flame retardants can be roughly divided into a halogen flame retardant that contains a halogen element and a non-halogen flame retardant that does not contain a halogen element, and either of the flame retardants may be used in the invention. Examples of the halogen flame retardant that contains a halogen element include a bromine compound, a chlorine compound, and a halogen-containing phosphorus compound (for example, a halogen-containing phosphate ester). In this case, as a flame retardant assistant, inorganic compounds such as antimony trioxide (Sb₂O₃), zinc sulfide (ZnS), zinc borate, and zinc stannate may be used in combination.

The non-halogen flame retardant that does not contain a halogen element is classified into inorganic and organic types. Examples of inorganic non-halogen flame retardants include a hydrated metal compound such as aluminum hydroxide, magnesium hydroxide, and calcium aluminate, a phosphorus compound such as red phosphorus, a nitrogen compound such as ammonium phosphate and ammonium carbonate, and an inorganic compound such as a molybdenum compound, zinc boron, and zinc stannate.

On the other hand, examples of organic non-halogen flame retardants include a halogen-free phosphorus compound such as a phosphate ester, a phosphorus-containing polyol, and a phosphorus-containing amine, a silicone compound such as silicone polymer powder, and a halogen-free nitrogen compound such as a triazine compound, melamine cyanurate, and a guanidine compound.

Among these, in the invention, a non-halogen flame retardant which is less likely to generate a toxic gas due to decomposition by heat is preferred, and among these, an organic non-halogen flame retardant is preferred, and further, among these, a phosphate ester is more preferred because a gas generated during combustion is safer for a human body.

In the invention, the flame retardant is preferably contained in the adhesive layer N in a range of 10 wt % or more and 30 wt % or less. It is possible to further improve the flame retardance of the entire filter structure 81, and the required adhesive force can be secured when the filter structure 81 is attached to the attachment object, and thus the filter structure 81 is prevented from peeling off or falling off. When a content of the flame retardant in the adhesive layer N exceeds 30 wt %, an amount of the adhesive in the adhesive layer N decreases, so that the adhesive force of the filter structure 81 may be reduced, and the filter structure 81 may peel off or fall off from the attachment object. In particular, when the filter structure 81 is used for a range hood, if the filter structure 81 peels off or falls off during heating cooking, a fire from a gas stove may spread to the filter structure 81, which is not preferable.

In the invention, it is preferable that the other surface of the filter layer S, which corresponds to a back surface of a range where the adhesive layer N is formed on the filter layer S, has a category of 3 in a flammability test according to a JIS L1091A-1 method (45° micro burner method). With such a configuration, the flame retardance of the entire filter structure is improved.

The filter structure 81 of the invention can be widely used as an air filter product in ventilation points of industrial equipment, in addition to household appliances such as a range hood in a kitchen or a cooking room, an air conditioner, and a ventilation fan, and indoor and outdoor vent holes, for example. Among these, the filter structure 81 has high flame retardance, and thus can be suitably used in a range hood.

The filter structure 81 of the invention may be applied to an object having a surface with plating such as aluminum-zinc alloy plating or a coating such as a polyester coating. In particular, a range hood generally used is often formed by a steel plate having a surface with various plating or polyester coatings, but the filter structure 81 of the invention can be applied to an object having a surface with plating or a coating as described above, thereby further preventing occurrence of adhesive residues when the filter structure 81 is removed.

The adhesive layer N may display letters, marks, patterns, and the like to indicate a replacement time of a filter. As a result of the filter layer S being colored when oil smoke or dust in air is captured in a portion other than the letters or the like, colorless letters or the like that are hardly identified before the start of use are colored at surroundings with elapse of a use time, so that the letters or the like become white letters and can be clearly read. Therefore, a filter replacement time can be displayed to a user by setting in advance a content displayed based on letters or the like to indicate the filter replacement time.

The filter structure 81 of the invention can be used as a relatively large product in which at least one length of the filter layers S is, for example, 25 cm or more. When at least one length of the filter layer S is 30 cm or more or further 35 cm or more, as the filter structure 81 is a large product, a problem such as falling off or partial peeling from an object due to its own weight is likely to occur. In particular, when the filter structure 81 is used for a range hood, a size of the filter structure 81 to be used varies depending on each model, but generally, at least one length is several tens of centimeters or more. Therefore, when the invention is applied to such a large filter structure 81, even when the filter structure 81 is attached to an object under a low temperature condition of 5° C., the filter structure 81 does not fall off from the object.

### EXAMPLES

An effect of improving flame retardance obtained by the filter structure of the invention was demonstrated by tests.

A sample used was a filter structure that was made assuming for a metal filter of a range hood and in which an adhesive layer was formed by different methods on one surface of each filter layer made of a nonwoven fabric having a basis weight and air permeability to be described later.

A nonwoven fabric produced from fibers using polyethylene terephthalate (PET) as a raw material was used as the filter layer. The fibers using PET as the raw material contain 40 wt % of PET fibers to which flame retardance is imparted. In the filter layer alone (filter layer before forming the adhesive layer), test results of 1) JIS L 1091 A-1 method (45° micro burner method) were classified as a category 3 for all filter layers, and test results of 2) vertical combustion test (after flame time and presence or absence of dripping) were classified as “A” for the after flame time and the presence or absence of dripping for all filter layers, as described later.

As the adhesive layer, a hot melt adhesive and a solvent adhesive were prepared to produce a filter structure sample. As for the hot melt adhesive, a rubber hot melt adhesive was used in Example 13 and Comparative Example 6, and an acrylic hot melt adhesive was used in the other Examples and Comparative Examples. As for the solvent adhesive, a two-part mixture type polyurethane adhesive containing a base agent and a curing agent was used.

The adhesive layer was formed by pattern coating (band-shaped adhesive pattern is formed on the surface of the filter layer by a method in which the adhesive is temporarily applied to the release sheet in a desired pattern design, and then the release sheet layer is brought into contact with the filter layer to transfer the adhesive to the filter layer) and spray coating (method in which the adhesive is blown entirely or partly on one surface of the filter layer by spraying, thereby forming the adhesive layer on the filter layer). In the pattern coating, the adhesive layer was formed with a band-shaped adhesive pattern having a width of 1 cm that was wrapping around an outer periphery of the filter layer and grid-shaped adhesive patterns having a width of 1 cm that were arranged at intervals of 5 cm in up-down and left-right directions.

As the range hood used for the tests, a model number “BDR-3HL-601BK” manufactured by Fuji Industries Co., Ltd. was used.

Five types of tests were performed which include 1) JIS L 1091 A-1 method (45° micro burner method), 2) vertical combustion test (after flame time and presence or absence of dripping), 3) adhesive force 1 of filter structure to metal filter (maximum peeling load at 5° C.), 4) adhesive force 2 of filter structure to metal filter (observation of state after attachment of filter structure to metal filter), and 5) air permeability.

### 1) JIS L 1091 a-1 Method (45° Micro Burner Method)

The method is a method of measuring a degree of spread of combustion (combustion area and combustion length), and after flame and afterglow time. The measurement was used to evaluate whether the sample fell into a category 1, 2, or 3 after 1 minute of heating and 3 seconds of flame application according to a flammability category defined by the A-1 method.

2) Vertical Combustion Test (after Flame Time and Presence or Absence of Dripping)

For each of filter structures of Examples and Comparative Examples, a strip of 5 cm×15 cm width was cut out, the test strip was held in a vertical direction, and a tip of a flame was applied to a lower end of 5 cm. A place where the flame was applied was a location where the adhesive layer was formed. Evaluation was performed based on evaluation criteria shown in Table 1 below.

TABLE 1

| | | |
|---|---|---|
| After flame time | 0 seconds or more and less than 3 seconds | A |
| | 3 seconds or more and less than 5 seconds | B |
| | 5 seconds or more | C |
| Dripping | None | A |
| | Doubtful (melts into icicle shape but does not | B |
| | melt off) | |
| | Dripping (applicable, even if only one drop drips) | C |

### 3) Adhesive Force 1 of Filter Structure to Metal Filter (Maximum Peeling Load at 5° C.)

A basic measurement method for the “maximum peeling load” was in accordance with “JIS Z 0237:2009”, but measurement conditions were as described below. The test was performed by setting a temperature environment to 5° C. As the “maximum peeling load”, a maximum load at the time of peeling from an object after attaching the sample to the object was measured. A constant speed extension tester was used as a test machine, and filter structures with a width of 5 mm×a length of 250 mm and a width of 10 mm×a length of 250 mm (adhesive layer also had the same dimensions) were prepared as samples. A stainless steel plate of SUS304 was used as a target surface to be attached. The test was performed by a method in which the sample was attached to the above target surface, and the surface was pressed back and forth twice with a roller of 1 kg, and then a maximum load was measured when the sample was peeled at a peeling rate of 100 mm/min in a 180-degree direction. The sample was evaluated as “A” when the maximum peeling load at this time was 0.02 N/mm or more, was evaluated as “B” when the maximum peeling load was 0.01 N/mm or more and less than 0.02 N/mm, and was evaluated as “C” when the maximum peeling load was less than 0.01 N/mm.

4) Adhesive Force 2 of Filter Structure to Metal Filter (Observation of State after Attachment of Filter Structure to Metal Filter)

The metal filter is removed from the range hood, and the metal filter is placed on a horizontal stand. A filter structure of the same dimension as the metal filter was prepared, and the filter structure was attached such that a surface on which an adhesive layer was formed was attached to a surface of the metal filter. In the attachment, while the filter structure of a specified dimension was placed on the surface of the metal filter, a surface of the filter structure on which the adhesive layer was not formed was pressed back and forth once with a roller at a pressure of 2 kg/cm². After that, after 10 minutes, the metal filter was raised to a vertical position and the presence or absence of the filter structure falling off from the metal filter was evaluated by visual observation. That is, a case where no falling off of the filter structure was observed from the metal filter was evaluated as “A”, a case where some peeling of the filter structure was observed from the metal filter but the filter structure did not fall off was evaluated as “B”, and a case where the filter structure fell off from the metal filter was evaluated as “C”. The test was performed by setting a temperature environment to 5° C.

### 5) Air Permeability (Ventilation Rate)

A ventilation rate (cc/cm²·sec) of the filter was measured according to a JIS L 1096 A method (Frazier method).

Test results are shown in Table 2 below.

TABLE 2

| | | | | | Flame | | | | | | |
|---|---|---|---|---|---|---|---|---|---|---|---|
| | | | Adhesive | | retardant | JIS L 1091 | Vertical | | | | |
| Example/ | | | coating | | content of | A-1 method | combustion test | | | | |
| Compar- | Basis | Coating | mode for | | adhesive | (45° micro | After | | | | Ventilation |
| ative | weight | amount of | nonwoven | Adhesive | layer | burner | flame | | Adhesive | Adhesive | rate |
| Example | of filter | adhesive | fabric | system | (wt %) | method) | time | Dripping | force 1 | force 2 | (cc/cm² · sec) |
| Example 1 | 70 | 30 g/m² | Pattern | Hot melt | 3 | Category 3 | B | B | A | A | 487 |
| | | | coating | (acrylic) | | | | | | | |
| | | | (transfer) | | | | | | | | |
| Example 2 | 70 | 30 g/m² | Pattern | Hot melt | 10 | Category 3 | B | A | A | A | 500 |
| | | | coating | (acrylic) | | | | | | | |
| | | | (transfer) | | | | | | | | |
| Example 3 | 70 | 30 g/m² | Pattern | Hot melt | 15 | Category 3 | A | A | A | A | 496 |
| | | | coating | (acrylic) | | | | | | | |
| | | | (transfer) | | | | | | | | |
| Example 4 | 70 | 30 g/m² | Pattern | Hot melt | 20 | Category 3 | A | A | A | A | 512 |
| | | | coating | (acrylic) | | | | | | | |
| | | | (transfer) | | | | | | | | |
| Example 5 | 70 | 30 g/m² | Pattern | Hot melt | 25 | Category 3 | A | A | A | A | 503 |
| | | | coating | (acrylic) | | | | | | | |
| | | | (transfer) | | | | | | | | |
| Example 6 | 70 | 30 g/m² | Pattern | Hot melt | 30 | Category 3 | A | A | A | A | 489 |
| | | | coating | (acrylic) | | | | | | | |
| | | | (transfer) | | | | | | | | |
| Example 7 | 70 | 10 g/m² | Spray | Hot melt | 15 | Category 3 | A | A | A | A | 293 |
| | | | coating | (acrylic) | | | | | | | |
| Example 8 | 70 | 10 g/m² | Spray | Hot melt | 20 | Category 3 | A | A | A | A | 302 |
| | | | coating | (acrylic) | | | | | | | |
| Example 9 | 70 | 10 g/m² | Spray | Hot melt | 25 | Category 3 | A | A | A | A | 297 |
| | | | coating | (acrylic) | | | | | | | |
| Example 10 | 70 | 10 g/m² | Spray | Hot melt | 30 | Category 3 | A | A | B | B | 305 |
| | | | coating | (acrylic) | | | | | | | |
| Example 11 | 70 | 30 g/m² | Pattern | Solvent | 15 | Category 3 | A | A | A | A | 492 |
| | | | coating | | | | | | | | |
| | | | (transfer) | | | | | | | | |
| Example 12 | 70 | 15 g/m² | Spray | Solvent | 15 | Category 3 | A | A | A | A | 293 |
| | | | coating | | | | | | | | |
| Example 13 | 30 | 10 g/m² | Spray | Hot melt | 30 | Category 3 | A | A | A | A | 580 |
| | | | coating | (rubber) | | | | | | | |
| Example 14 | 70 | 15 g/m² | Spray | Hot melt | 40 | Category 3 | A | A | A | B | 286 |
| | | | coating | (acrylic) | | | | | | | |
| Compar- | 70 | 10 g/m² | Spray | Hot melt | 0 | Category 1 | C | C | A | A | 293 |
| ative | | | coating | (acrylic) | | | | | | | |
| Example 1 | | | | | | | | | | | |
| Compar- | 70 | 10 g/m² | Spray | Hot melt | 2 | Category 1 | C | C | A | A | 314 |
| ative | | | coating | (acrylic) | | | | | | | |
| Example 2 | | | | | | | | | | | |
| Compar- | 80 | 10 g/m² | Spray | Hot melt | 0 | Category 1 | C | C | A | A | 263 |
| ative | | | coating | (acrylic) | | | | | | | |
| Example 3 | | | | | | | | | | | |
| Compar- | 60 | 20 g/m² | Spray | Hot melt | 0 | Category 1 | C | C | A | A | 320 |
| ative | | | coating | (acrylic) | | | | | | | |
| Example 4 | | | | | | | | | | | |
| Compar- | 70 | 30 g/m² | Pattern | Hot melt | 0 | Category 1 | C | C | A | A | 492 |
| ative | | | coating | (acrylic) | | | | | | | |
| Example 5 | | | (transfer) | | | | | | | | |
| Compar- | 30 | 10 g/m² | Spray | Hot melt | 0 | Category 1 | C | C | A | A | 590 |
| ative | | | coating | (rubber) | | | | | | | |
| Example 6 | | | | | | | | | | | |

### INDUSTRIAL APPLICABILITY

The invention can be used as, for example, a filter structure for filtering a gas passing therethrough by being attached to an object such as a range hood, an air conditioner, an air purifier, or a vent hole.

1. A filter structure (81) for filtering a gas passing therethrough by being attached to an object, the filter structure comprising:
a filter layer made of a sheet-like member having air permeability; and
an adhesive layer formed on at least a part of one surface of the filter layer and configured to attach to the object, wherein
the adhesive layer contains 3 wt % or more of a flame retardant.

2. The filter structure according to claim 1, wherein
the flame retardant is an organic non-halogen flame retardant.

3. The filter structure according to claim 1, wherein
the flame retardant is contained in the adhesive layer in a range of 10 wt % or more and 30 wt % or less.

4. The filter structure according to claim 1, wherein
at a location on the filter layer where the adhesive layer is formed, the adhesive layer is formed in a range of 5 g/m² or more and 50 g/m² or less with respect to the filter layer.

5. The filter structure according to claim 1, wherein
the adhesive layer is formed by spray coating.

6. The filter structure according to claim 1, wherein
the other surface of the filter layer, which corresponds to a back surface of a range where the adhesive layer is formed on the filter layer, has a category of 3 in a flammability test according to a JIS L1091A-1 method (45° micro burner method).

7. The filter structure according to claim 1, wherein
the object is a range hood.
